(19) United States
(12) Patent Application Publication
(10) Pub. No.: US 2007/0211866 A1
(43) Pub. Date: Sep. 13, 2007

(54) PUBLIC SAFETY WARNING NETWORK

(75) Inventor: Gregory A. Sink, Frankfort, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: FEDERAL SIGNAL CORPORATION, Oakbrook, IL (US)

(21) Appl. No.: 11/677,481

(22) Filed: Feb. 21, 2007

Related U.S. Application Data
(63) Continuation-in-part of application No. 11/548,209, filed on Oct. 10, 2006.
(63) Continuation-in-part of application No. 11/558,802, filed on Nov. 10, 2006.
(63) Continuation-in-part of application No. 11/505,642, filed on Aug. 17, 2006.
(60) Provisional application No. 60/775,634, filed on Feb. 22, 2006.

(51) Int. Cl. H04M 11/04

(52) U.S. Cl. 379/37

(57) ABSTRACT

A communications infrastructure is upgraded to a public safety network that supports wireless communications of emergency information. Communities have installed public safety communications systems such as community warning siren systems that rely on point-to-point communications systems. Each site in the system is upgraded to a node in a wireless network that provides the communications infrastructure for a network-enabled public safety communications system that enables trusted resources such as warning sirens to access the network and communicate with other trusted resources across the network. Additionally, the public safety network may be patched using mobile transceivers to form an ad hoc network in the event part of the infrastructure supporting the emergency response network is lost. Additionally, the upgrading of the communications system may include a public access network that relies on at least some of the same communications sites or nodes employed by the public safety network.

### CROSS-REFERENCE TO RELATED APPLICATIONS

Pursuant to 35 U.S.C. § 119, this patent application claims the benefit of U.S. Provisional Patent Application No. 60/775,634, filed Feb. 22, 2006. This patent application is a continuation-in-part of co-pending U.S. patent application Ser. No. 11/548,209, filed Oct. 10, 2006, Ser. No. 11/558,802, filed Nov. 10, 2006, and Ser. No. 11/505,642, filed Aug. 17, 2006. This application is also related to co-pending U.S. patent application no. <Atty Dkt. No. 251174>, filed Feb. 21, 2007 and entitled “Networked Fire Station Management,” naming Greg Sink as the inventor. Each of these applications is hereby incorporated by reference in its entirety and for everything it describes.

### BACKGROUND OF THE INVENTION

Communities deploy a multitude of systems and networks to monitor and respond to local conditions and emergencies. For example, many communities deploy outdoor warning sirens to warn citizens of impending dangers, such as tornados. Outdoor warning sirens operate on a dedicated wired or wireless network. In the United States, the National Weather Service issues alerts to communities in the path of severe weather such as a tornado. Communities also monitor weather conditions through metrological monitoring stations and storm spotters. The community Emergency Management Office issues alerts to citizens of impending danger by activating the warning sirens.

Supervisory Control and Data Acquisition (SCADA) systems monitor and control various functions throughout a community. For example, community warning sirens, municipal water supplies, electric power generation and distribution, gas and oil pipelines, flood control systems, cellular telephone base stations and various other public service resources are monitored using SCADA systems. Each SCADA system requires its own network. For example, a community Public Works Department monitors and manages the municipal water supply through one dedicated network. A separate SCADA network is used to monitor electric power generation and the electric distribution network. Additional networks monitor a community's gas and oil pipelines.

A community's emergency services personnel deploy additional networks to monitor and respond to events in the community. For example, police departments, fire departments and other emergency responders rely on dedicated point to point and point to multi-point communications systems operating at various frequencies including frequencies in the VHF and UHF bands. Increasingly, communities are deploying communications systems operating in the regulated 4.9 GHz public safety band. Many communities deploy systems of distributed cameras to monitor and deter crime. The camera systems operate on yet another separate, dedicated network. In addition, emergency service personnel increasingly rely on broadband networks to transmit data and voice. Broadband networks facilitate communicating multiple types of data and allow multiple users to access the system. One example broadband network is wireless fidelity (Wi-Fi) based on the Institute of Electrical and Electronics Engineers (IEEE) 802.11 specification. However, other networks such as cellular networks are also used.

The integrity and reliability of many of these public service networks are critical in emergencies. Typically, these systems rely on the community's power grid. If the grid fails either partially or completely in an emergency, then the public service networks must rely on sources of back up or auxiliary power to maintain operation. Some public service networks, such as outdoor warning siren systems, provide a battery backup at each siren installation in case of failure of the power grid. However, some systems do not include redundant power supplies. If an emergency compromises a community's power grid, emergency services without auxiliary power are also compromised. In distributed systems, adding auxiliary power can be expensive.

Regardless of whether auxiliary power is available, managing, installing and servicing all of the separate systems in a community are time intensive and expensive undertakings. The networks are not interconnected and do not share data. Service personnel must travel to each end node and install, maintain or upgrade network equipment. Locating an appropriate site to mount networking nodes is difficult. To provide maximum coverage, nodes must be elevated above ground level and power must be provided at each site. Within each of the networks, this process is highly redundant. However, from one network to another the servicing can be quite different and require different training and skills.

Recently, municipalities have begun to support public wireless internet access by deploying Wi-Fi based access points. Although these systems are aimed at the public access 2.4 GHz bandwidth, they may also support the regulated public safety 4.9 GHz bandwidth as well as other unregulated bandwidths such as 5.8 GHz. Municipalities partner with private businesses to deploy Wi-Fi systems throughout a community. The systems are typically deployed in a mesh network configuration in order to provide public access at 2.4 GHz. Typically, a community requires an average of 28 Wi-Fi access points per square mile in order to provide complete Wi-Fi coverage. Deploying the systems requires a substantial initial investment that municipalities often finance by partnering with private business who assume much of the installation and equipment expenses in order to derive revenue from ongoing operations of the Wi-Fi network. This strategy has been effective for large municipalities but may prove problematic for smaller communities that do not have a sufficiently large population to attract investment from private industry.

### BRIEF SUMMARY OF THE INVENTION

The invention provides methods of installing a community-wide emergency response network and includes methods for installing a combination of public safety networks, public access networks and backhaul networks. Initially, an existing public safety system is selected for upgrading. Example systems include outdoor warning sirens, water resource monitoring systems and other SCADA systems. After a system is selected for upgrading, transceivers are installed for a public safety network and a backhaul network. The Federal Communications Commission (FCC) reserved the 4.9 GHz frequency spectrum for use by community emergency service personnel, although other frequencies can be used. Backhaul transceivers operate at various frequencies. One preferred embodiment uses the IEEE 802.11a specification to implement the backhaul transceiver operating at 5.8 GHz. If the community-based assets already contain appropriate public safety or backhaul transceivers, those transceivers do not need to be installed.

After installing the public safety transceivers and backhaul transceivers it is determined whether there exists sufficient public safety network coverage. Sufficient public safety network coverage varies with the needs of a particular community. For example, one community may choose to provide ubiquitous coverage over the entire community. In this way, first responders may utilize the network in order to better respond to emergencies. Some communities may not need complete coverage for the public safety network. For example, some communities may only provide high density downtown areas with coverage, while more rural areas of the same community may not need public safety network coverage. If the coverage is not sufficient for a particular community, the coverage is extended. Typically, a community extends network coverage by adding additional nodes to the network.

A community may also install a public access network. The public access network is based on any appropriate network protocol. One example public access network protocol is Wi-Fi based on the IEEE 802.11 specification, although other network protocols and specifications can be used. After installing the public access transceivers, a community determines whether there is sufficient public access coverage. Some communities may provide ubiquitous public access network coverage. However, some communities may only provide public network coverage in densely populated areas. If additional coverage is needed, coverage is extended by adding additional transceivers until the public access network coverage is sufficient.

After a community warning system's communications infrastructure has been upgraded to support a community wide, wireless network, the network may be accessed by additional community resources. For example, mobile communication devices used by community trusted personnel such as police officers can access the network. Fire trucks, parking control devices and police vehicles can all access the public safety network. Data on the public safety network can be routed to a backhaul. The backhaul can route the data to the internet or to a community control center. The control center can be used to coordinate a community's emergency response and monitoring systems and to monitor community resources.

If an event destroys all or part of a community's network infrastructure, first responders and other trusted resources can continue to communicate with the control center by forming an ad hoc network with at least one node in the ad hoc network also connecting to the community wide network or directly to the control center. Additionally, if an event occurs beyond the range of the community wide network, an ad hoc network can be established to extend the range of the community wide network so that the network reaches the emergency. For example, police cars may form an ad hoc network to patch a whole in the community wide network. In this example, the ad hoc network formed by the police vehicles allows other trusted resources to access the network. For example, a police officer may use a handheld device to connect to the community wide network through the ad hoc network established by police vehicles.

The networking methods and systems according to various embodiments incorporate other features and advantages that will be more fully appreciated from the following description in conjunction with the accompanying figures.

### BRIEF DESCRIPTION OF THE SEVERAL VIEWS OF THE DRAWING(S)

FIG. 1 illustrates a community warning siren system including a communications infrastructure in keeping with existing installations;

FIG. 2 is an exemplary dedicated control and power system for the warning siren system illustrated in FIG. 1;

FIG. 3 is a flowchart illustrating one embodiment of a process for upgrading the community warning siren system of FIG. 1 to support a backhaul, public safety communications and public Wi-Fi access;

FIG. 4 illustrates the community warning system of FIG. 1 whose communications infrastructure has been upgraded in keeping with the process of FIG. 3 to support a community wide, wireless network that is accessible by additional community resources;

FIG. 5 illustrates SCADA community warning systems whose infrastructures have been upgraded to provide a community-wide, wireless network in keeping with the process illustrated in FIG. 3;

FIG. 6 illustrates typical community resources and public access devices that may connect to the community-wide, wireless networks of FIG. 5;

FIG. 7 illustrates one embodiment of a network upgrade module that is retrofitted to upgrade the installed base of the community warning siren system of FIGS. 1 and 4 and the SCADA community warning system of FIG. 5;

FIG. 8 illustrates another embodiment of a network upgrade module having a Wi-Fi transceiver, a public safety network transceiver and a back-haul transceiver for retrofitting an installed base of community assets such as the community warning system illustrated in FIG. 1;

FIG. 9 illustrates various backhaul deployments in the community-wide, wireless network systems illustrated in FIGS. 4, 5 and 6; and

FIG. 10 illustrates a mobile ad hoc network normally supported by the community-wide, wireless network systems illustrated in FIGS. 4 and 5 that effectively patches holes in the network in the event that part of the infrastructure supporting the community-wide, wireless network is lost.

### DETAILED DESCRIPTION OF THE INVENTION

The following description is intended to convey the operation of exemplary embodiments of the invention. It will be appreciated that this description is intended to aid the reader, not to limit the invention. As such, references to a feature or aspect of the invention are intended to describe a feature or aspect of an embodiment of the invention, not to imply that every embodiment of the invention must have the described characteristic.

Many governmental and non-governmental agencies deploy networks throughout a community. For example, many communities deploy outdoor warning sirens to warn citizens of impending dangers, such as tornados. Outdoor warning sirens operate on a dedicated wired or wireless network Supervisory Control and Data Acquisition (SCADA) systems monitor and control various functions throughout a community. For example, community warning sirens, municipal water supplies, electric power generation and distribution, gas and oil pipelines, flood control systems, cellular telephone base stations and various other public service resources are monitored using SCADA systems. Each SCADA system requires its own network. Police departments, fire departments and other emergency responders rely on dedicated point to point and point to multi-point communications systems operating at various frequencies including frequencies in the VHF and UHF bands. Recently, municipalities have begun to support public wireless internet access by deploying wireless fidelity (Wi-Fi) access points based on the Institute of Electrical and Electronics Engineers (IEEE) 802.11 specification. However, other networks such as cellular networks are also used for public network access.

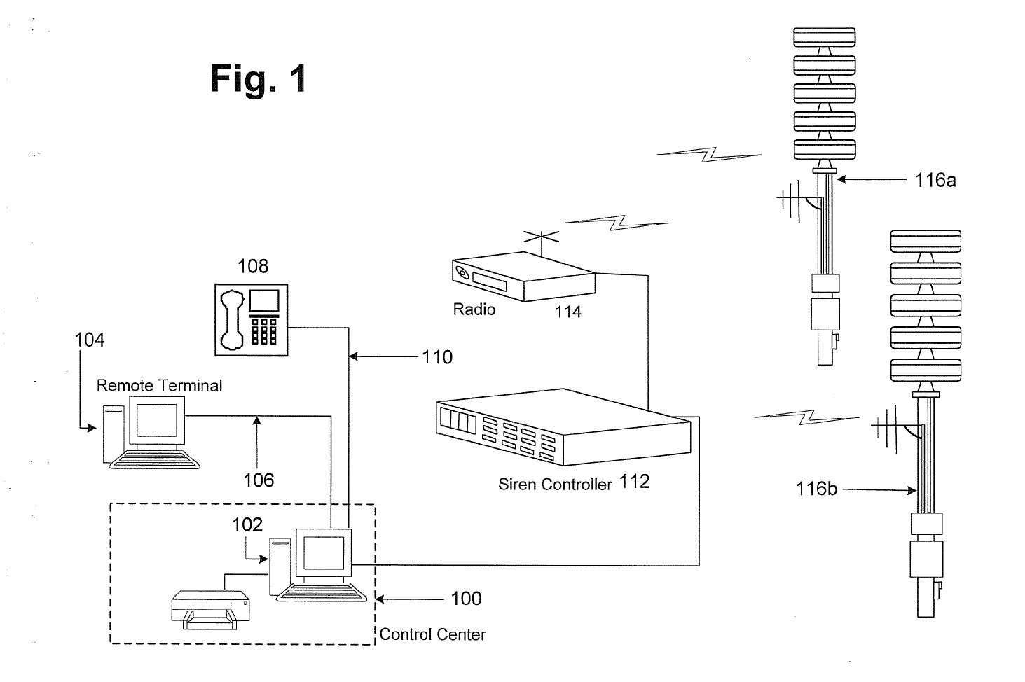

Many communities use outdoor emergency warning sirens to alert citizens of impending dangers, such as tornados. Outdoor warning sirens operate on a dedicated wired or wireless network. In the United States, the National Weather Service issues alerts to communities in the path of severe weather such as a tornado. Communities also monitor weather conditions through metrological monitoring stations and storm spotters. The community Emergency Management Office issues alerts to citizens of impending danger by activating the warning sirens. FIG. 1 illustrates a community warning siren system including a communications infrastructure in keeping with existing installations. The control center 100 includes a computing device 102. By way of example, control center 100 may be based on the Federal Commander Digital System™ from Federal Signal Corporation, University Park, Ill. The command center receives weather alerts from the National Weather Service, meteorological monitoring stations and storm spotters. Alerts are received through either automated or manual means. For example, remote terminal 104 may issue an alert based on an automated meteorological monitoring station. The alert is transmitted to the control center computer 102 via a network 106 that is wired or wireless. Human storm spotters can use a telephone 108 to call the control center 100 with severe weather alerts. The telephone network 110 is wired or wireless, such as a cellular network.

After receiving an alert from any of a remote terminal 104, a storm spotter or the National Weather Service, the command center 100 activates the siren controller 112. By way of example, siren controller 112 may be based on the SS2000D from Federal Signal Corporation, University Park, Ill. The siren controller 112 interfaces with the command center computer 102 thru any appropriate communications link such as universal serial bus (USB) based on the USB Implementers Forum standard or FireWire based on the IEEE 1394 standard. The SS2000) siren controller uses a serial RS-232 connection based on the Electronic Industries Alliance (EIA) RS-232 standard. The siren controller 112 can activate a number of sirens in various zones. For example, the SS2000D siren controller can activate more than 250 sirens in 16 zones. In this example, the siren controller 112 interfaces with a radio 114. The radio 114 wirelessly activates sirens 116a, 116b in a community. One example siren is the Modulator Series Siren from Federal Signal Corporation, University Park, Ill.

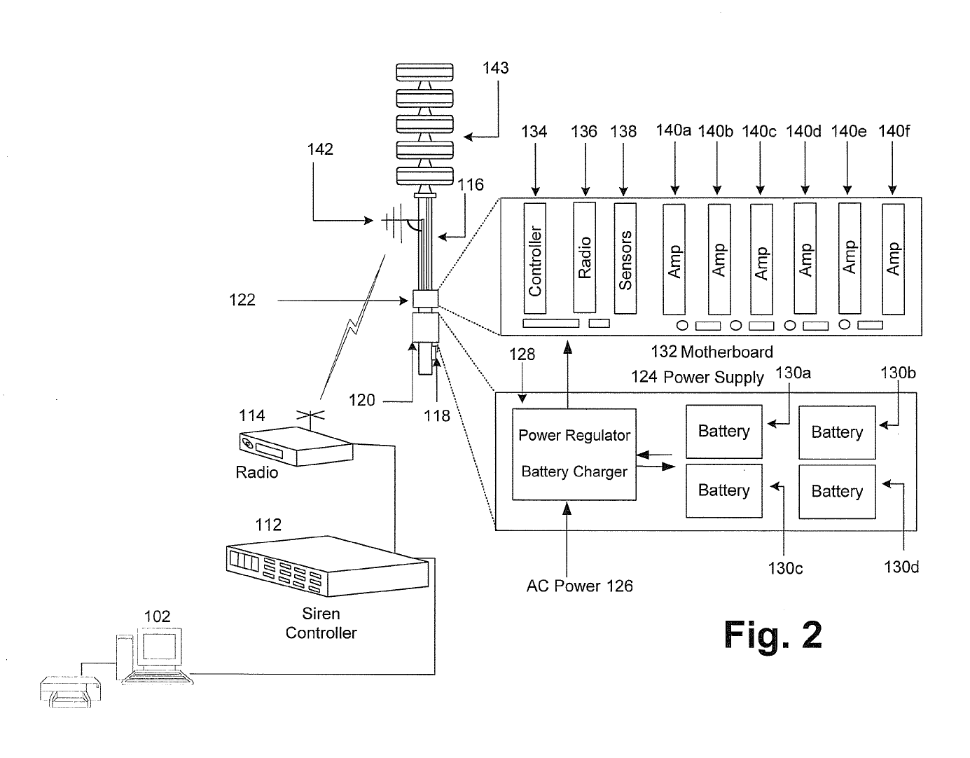

FIG. 2 is an exemplary dedicated control and power system for the warning siren system illustrated in FIG. 1. The illustrated community siren 116 includes a 120 volt alternating current (AC) single-phase meter base with main disconnect 118 that provides the siren with electrical power from the community power grid. A battery cabinet 120 houses batteries and a power regulator in a National Electrical Manufacturers Association (NEMA) certified enclosure. The batteries provide power to the siren in the event that the main power supply 118 no longer receives power from the power grid. For example, natural or man made events can disrupt a community's power grid. Power supply 124 illustrates the batteries and circuitry housed in battery cabinet 120. The main power system 118 provides AC power 126 to the battery compartment 120. The AC power 126 is used by power regulator and battery charger 128 to charge the siren's 116 batteries 130a, 130b, 130c and 130d. If the AC power 126 is interrupted for any reason, the power regulator 128 begins drawing power from the batteries 130a-d. Therefore, the power supply 124 can supply power to the motherboard 132 housed in a control cabinet 122.

The control cabinet 122 houses the control electronics for the siren in a second NEMA certified enclosure. The motherboard 132 interfaces with the power supply 124 and provides power to the electronics housed in the control cabinet 122. A controller 134 interfaces with a radio module 136, sensors 138 and amplifiers 140a-140f. The radio module 136 can be housed inside the electronics enclosure 122 or in a separate housing. The radio module 136 connects to an antenna 142 to send and receive wireless signals with the control center radio 114. For example, if the control center 100 activates an alarm, a signal is sent from the control center computer 102 to the siren controller 112. The siren controller 112 activates the appropriate sirens by sending a signal to the radio 114. The radio 114 wirelessly transmits the signal and it is received by the antenna 142 and the radio module 136. The radio module 136 sends the alert to the controller 134 where it is verified. The controller 134 activates an audible community alarm by sending a tone or voice command to the amplifiers 140a-140f. The amplifiers 140 amplify the signal and send it to the omni-directional sirens 143.

The siren 116 may include sensors to monitor systems on the siren. For example, a sensor may monitor the battery 130 charge level. If the battery 130 charge is below a certain threshold, the sensors 138 notify the controller 134. The controller 134 uses the radio 136 to send a signal to the control center radio 114 and the siren controller 112. The siren controller 112 then notifies control center personnel through, for example the control center computer 102.

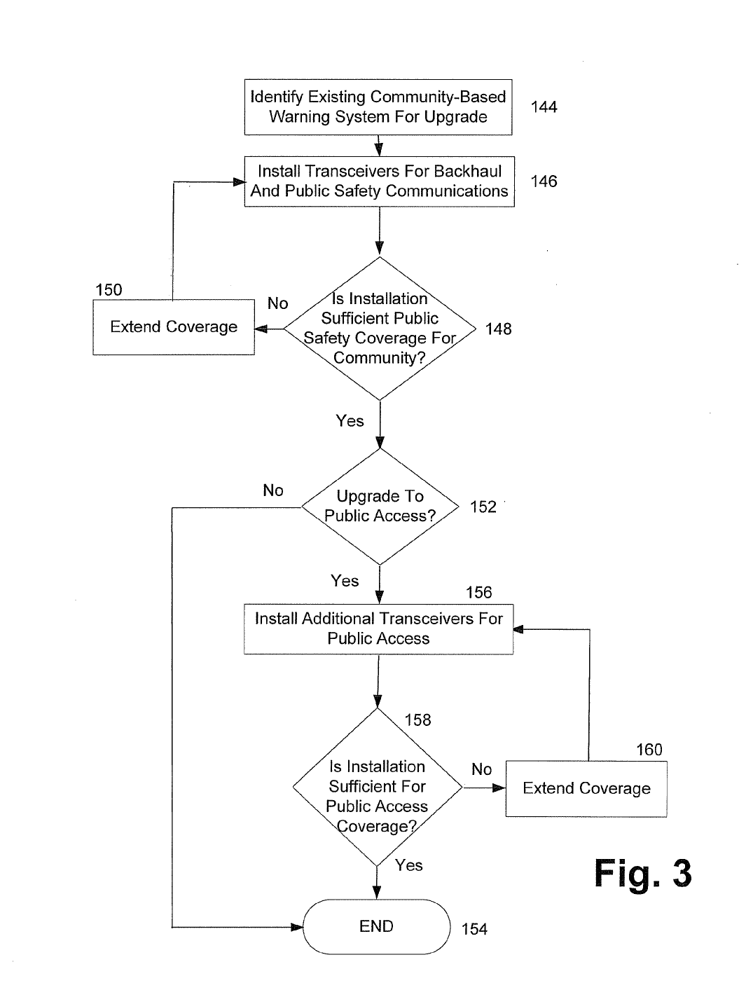

FIG. 3 illustrates one method of implementing a wireless community based network system in keeping with one embodiment of the invention. The method begins at step 144 where an existing community-based warning system is identified. The method illustrated in FIG. 3 can alternatively be applied to other community based assets such as SCADA systems. Additional community resources such as police stations, fire stations and other structures can be used in place of the community based warning system in step 144. The process of upgrading an existing system includes replacing parts or all of the community-based system. An exemplary existing community based warning system is the siren warning system illustrated in FIG. 1 and FIG. 2. After identifying the existing system to upgrade at step 144, transceivers are installed for a public safety network and a backhaul network. Alternatively, the existing system can be upgraded by replacing it with a new system containing the transceivers. For example, during the process of upgrading the siren warning system illustrated in FIG. 1 and FIG. 2, some communities may upgrade the existing sirens 116 by replacing the existing sirens with new sirens containing public safety transceivers. The existing community-based warning system can alternatively be a local warning system, such as a system of fire waning devices such as smoke detectors or fire sirens located within a building. Thus, the indoor warning system is upgraded to include transceivers.

The Federal Communications Commission (FCC) has reserved the 4.9 GHz frequency spectrum for use by community emergency service personnel. In one preferred embodiment of the invention, the public safety transceiver installed at step 146 operates in the 4.9 GHz spectrum, although other frequencies can also be used. Backhaul transceivers can operate at various frequencies. One preferred embodiment uses the IEEE 802.11a specification to implement the backhaul transceiver operating at 5.8 GHz. If the community based assets identified in step 144 already contain appropriate public safety or backhaul transceivers, those transceivers do not need to be installed at step 146.

In some embodiments of the invention, implementing a public safety network reduces the number of dedicated single purpose networks. For example, the warning siren system of FIG. 1 and FIG. 2 may operate on the common public safety network rather than on a dedicated network. Certain additional SCADA and public safety systems can be converted to operate on the 4.9 GHz public safety network rather than on individual, dedicated networks.

After installing the public safety transceiver and backhaul transceiver at step 146, at step 148 it is determined whether there exists sufficient public safety network coverage. Sufficient public safety network coverage varies with the needs of a particular community. For example, one community may choose to provide ubiquitous coverage over the entire community. In this way, first responders may utilize the network in order to better respond to emergencies. Some communities may not need complete coverage for the public safety network. For example, some communities may only provide high density downtown areas with coverage, while more rural areas of the same community may not need public safety network coverage.

If the coverage is not sufficient for a particular community, the coverage is extended at step 150. Typically, a community extends network coverage by adding additional nodes to the network at step 146. If the public safety network coverage is sufficient at step 148, a community determines whether to provide public network access at step 152. If a community does not provide public network access, the method ends at step 154. If the community does install a public access network, additional public access transceivers are installed at step 156. The public access network is based on any appropriate network protocol. One example public access network protocol is Wi-Fi based on the IEEE 802.11 specification, although other network protocols and specifications can be used. Additional examples of appropriate protocols include any IEEE 802.11 protocol such as IEEE 802.11a, 802.11b, 802.11g or 802.11n, Wi-Max and WiBro, both based on the IEEE 802.16 standard, and Hiperman based on the European Telecommunications Standards Institute protocol.

After installing the public access transceivers, a community determines at step 158 whether there is sufficient public access coverage. Some communities may provide ubiquitous public access network coverage. However, some communities may only provide public network coverage in densely populated areas. If additional coverage is needed, coverage is extended at step 160 by adding additional transceivers at step 156. When sufficient public access coverage exists, the method ends at step 154. Communities can implement various procedures for allowing access to the public access networks. For example, public access can be provided at no cost to end users. However, public access networks can also be limited to those who subscribe to the service or agree to view certain advertising. Communities may choose to collaborate with private companies to manage access to the networks. Additionally, communities may provide access to sites for installation of the networking equipment and private companies or governmental agencies may perform the network installation and/or manage the public access networks.

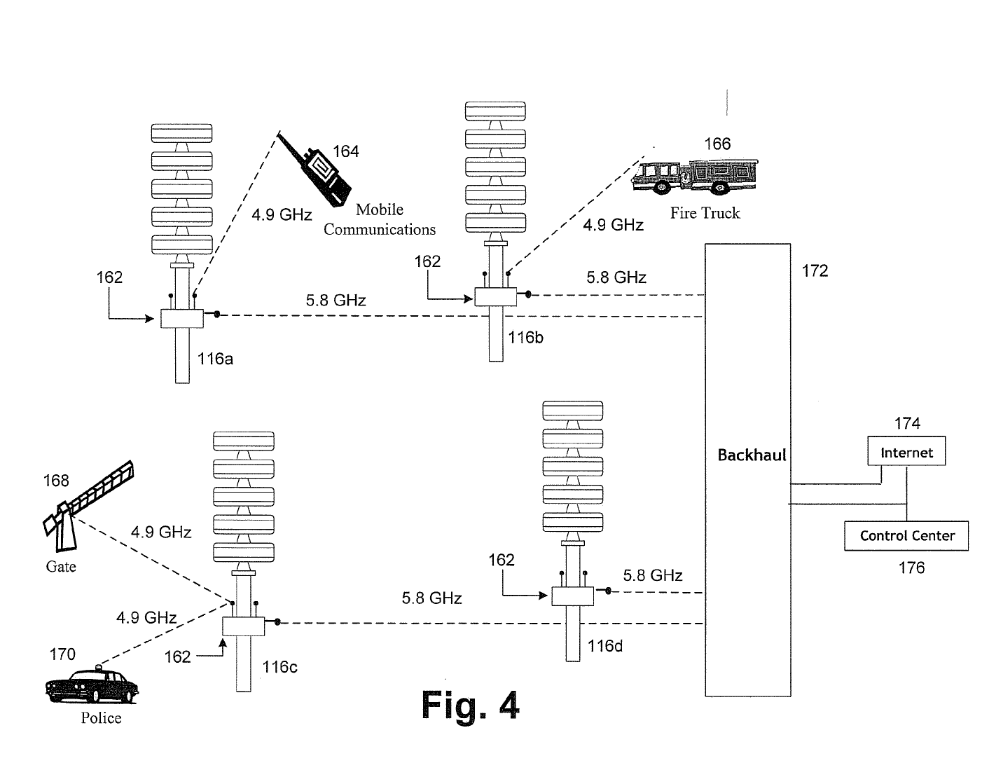

FIG. 4 illustrates the community warning system of FIG. 1 whose communications infrastructure has been upgraded in keeping with the process of FIG. 3 to support a community wide, wireless network that is accessible by additional community resources. Each siren 116 contains a radio module 162. The radio module can plug directly into the motherboard or can be a separate box. In this embodiment, the radio modules 162 contain a public safety transceiver and a backhaul transceiver. In this embodiment, the public safety network operates at 4.9 GHz and allows additional community resources to access the network. For example, mobile communication devices 164 used by community trusted personnel such as police officers can access the network. Fire trucks 166, parking gate 168 and police vehicle 170 can each access the public safety network. Data on the public safety network can be routed to a backhaul 172. The backhaul then routes data to the internet 174 or to a community control center 176. The various sites supporting the public safety network can be integrated together to form a mesh network or if, for example the network does not cover an entire community, the sites supporting the public safety network can operate independently, routing all traffic to the backhaul. Additionally, the radio modules 162 can be integrated into the power systems of the sites where they are installed. For example, a radio module 162 installed at a siren 116 can be integrated into the siren's power supply 124 (FIG. 2). In the event that power is lost at the siren, the siren and radio module 162 will operate from battery 130 power. Alternative power supplies, such as fuel cells and solar panels may also be used to provide power to the siren and radio module and to charge the batteries 130.

The control center 176 can take various forms including the control center described in co-pending U.S. patent application Ser. No. 11/505,642, filed Aug. 17, 2006, entitled “Integrated Municipal Management Console,” which is hereby incorporated by reference in its entirety and for everything that it describes.

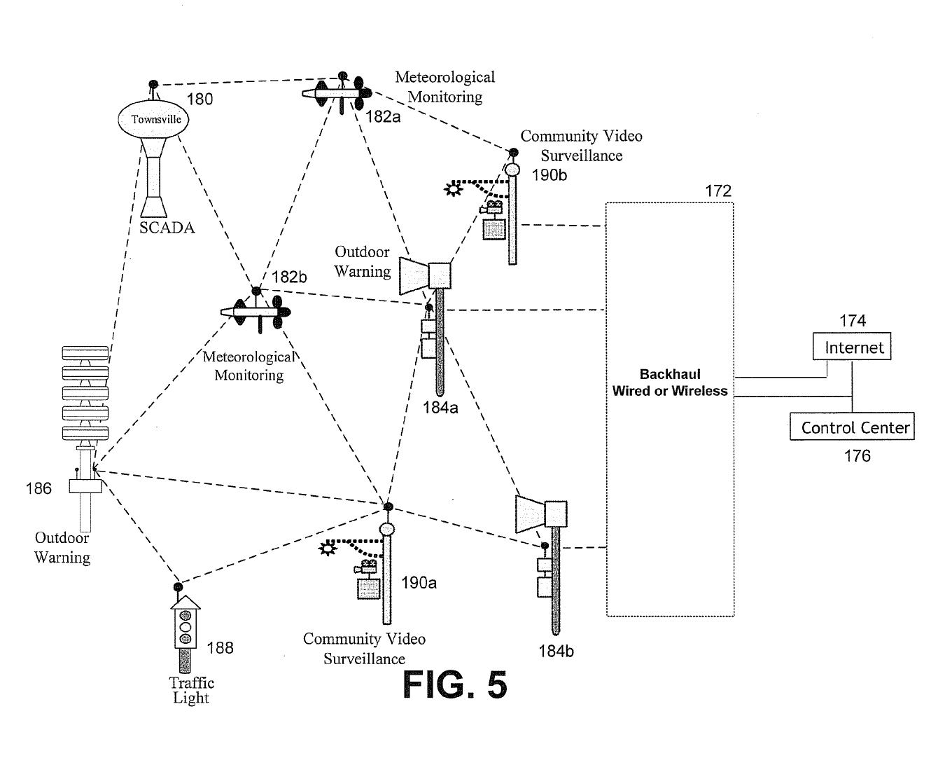

FIG. 5 illustrates SCADA community warning systems whose infrastructures have been upgraded to provide a community-wide, wireless network in keeping with the process illustrated in FIG. 3. In this embodiment of the invention, various types of community assets operate on a single community-wide mesh network. For example, water system 180, meteorological monitoring stations 182, outdoor warning sirens 184 and 186 of various types, traffic signals 188 and community video surveillance equipment 190 all connect to a single network. Allowing these various types of community assets to access a single network simplifies network installation and maintenance, allowing for a more robust network at a lower cost. Data on the network can be routed to the backhaul via wired or wireless network connections. For example, data entering the network node at the video surveillance camera 190b can be routed to the backhaul 172 and then routed to either the internet 174 or control center 176. Embodiments of the invention do not require any particular mix of community assets. For example, one embodiment of the invention is implemented using only the community warning siren system depicted in FIG. 1. However, as illustrated in FIG. 5, any combination of community assets may be used in implementing the process illustrated in FIG. 3.

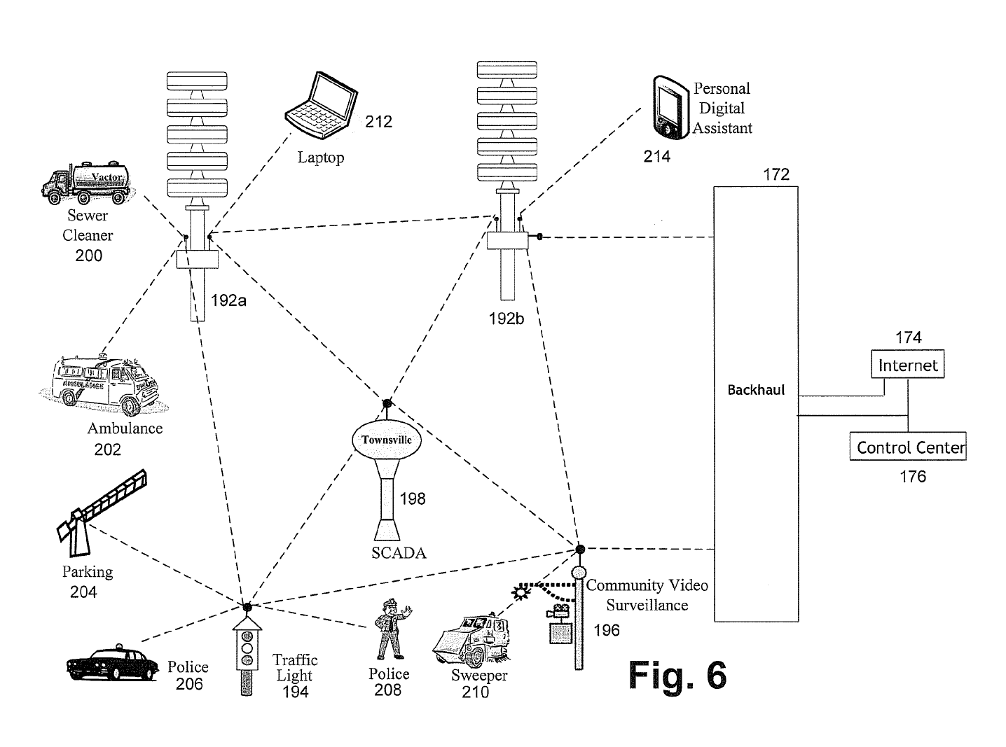

FIG. 6 illustrates typical community resources that may connect to the community-wide, wireless networks of FIGS. 4 and 5. In this embodiment, sirens 192, traffic light 194, video surveillance system 196 and SCADA water monitoring system 198 form the nodes in a mesh network providing both public access and public safety networks. In creating this network system, the community used the process illustrated in FIG. 3 to install both public safety transceivers and public access transceivers. Sewer cleaner 200, ambulance 202, parking control system 204, police vehicle 206 and sweeper 210 each connect to the public safety network as trusted community resources. Additionally, police officer 208 connects to the public safety network using a handheld radio, personnel digital assistant (PDA) or other mobile device capable of communications as a trusted resource. Trusted resources connected to the public safety network can communicate with the control center 176, the internet 174 or directly with one another using the public safety network. For example, police car 206 located at the scene of an emergency can send information regarding the emergency to ambulance 202 still in route to the scene of the emergency. In this way, trusted resources can efficiently communicate vital information such as video feeds, textual data and audible messages using voice over internet protocol (VoIP). An example implementation of a light bar for emergency vehicles capable of utilizing a public safety network to transmit data, video and voice is described in co-pending U.S. patent application Ser. No. 11/548,209, filed Oct. 10, 2006, entitled “Fully Integrated Light Bar,” which is hereby incorporated by reference in its entirety and for everything that it describes.

However, the nodes illustrated in this embodiment also contain transceivers for public access, allowing the public to connect devices to the public network. For example, laptop 212 and personal digital assistant 214 each connect to the public access network using Wi-Fi technology. Additional devices such as VoIP phones may also connect to the network. In some embodiments of the invention, any device capable of operating using the correct protocol can connect to the public access network. Data from the trusted resources is routed through the public safety network to the backhaul 172 and then to either the internet 174 or control center 176. Data from the public access devices is routed through the public access network to the backhaul 172 and then to the internet 174. Additional devices can access either the public access network or the public safety network. For example, an all warning hazard device may connect to either network to warn citizens of dangers. An example implementation of an all hazard warning device is described in co-pending U.S. patent application Ser. No. 11/558,802, filed Nov. 10, 2006, entitled “All Hazard Residential Warning System,” which is hereby incorporated by reference in its entirety and for everything that it describes. Some communities may also allow data from the public access network to be routed to the control center 176, for example to alert the control center 176 of possible dangerous conditions in the community.

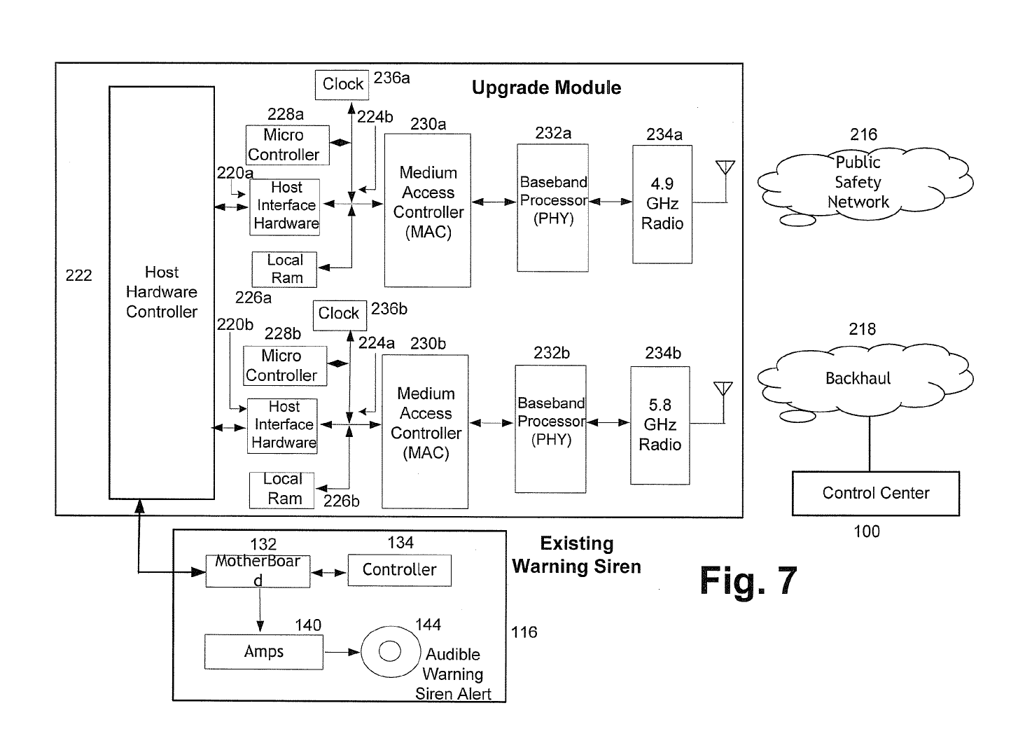

FIG. 7 illustrates one embodiment of a network upgrade module that is retrofitted to upgrade the installed base of the community warning siren system of FIGS. 1 and 4 and the SCADA community warning system of FIG. 5. This embodiment of the upgrade module includes a transceiver to access the public safety network 216 and the backhaul 218. However, other embodiments of the invention use separate modules to implement the public safety transceiver and backhaul transceiver. Any appropriate commercially available or proprietary network adapter may be used. For example, in the embodiment of the invention depicted in FIG. 7, two similar network adaptors are used. The host interface hardware 220 connects to the host hardware controller 222. The host hardware controller interfaces with the motherboard 132 (FIG. 2) and the controller 134. The host interface hardware 220 also connects to a bus 224. The bus 224 provides the host interface hardware 220 with access to local internal ram 226, an embedded micro-controller 228 and the medium access controller (MAC) 230. The MAC provides the data link layer for connectivity to the network. It sends and receives requests from the physical layer (PHY) 232. The PHY may include an integrated baseband processor. The PHY 232 connects to the radio 234, which transmits and receives wireless signals. A clock 236 controls the radio transceiver. Any suitable radio transceiver may be used to provide network connectivity to the alarm. The transceiver connecting to the public safety network 216 uses a 4.9 GHz radio 234a. Therefore, the exemplary public safety transceiver connects to public safety networks operating in the 4.9 GHz band. The transceiver connecting to the backhaul 218 uses a 5.8 GHz radio 234b. Therefore, the exemplary backhaul transceiver connects to the backhaul operating in the 5.8 GHz band.

Using the upgrade module illustrated in FIG. 7, the control center 100 can issue audible alarms to the community. For example, a storm spotter notifies the control center 100 of a tornado. The control center 100 sends a signal containing an alert to the backhaul 218 and it is received by the backhaul radio 234b in the upgrade module. After the PHY 232b, MAC 230b and host interface hardware 220b process the signal, the signal passes to the host hardware controller 222. The host hardware controller 222 notifies the controller 134 through the motherboard 132 of the alert. The controller 134 sends a tone or voice message to the amplifiers 140 and the amplifiers amplify the signal from the controller and send the amplified signal to the sirens 143. Citizens in the path of the tornado are thereby warned of the impending dangerous weather.

Similarly, in this embodiment, trusted resources such as the police vehicle 206 (FIG. 6) connect to the upgrade module through the public safety network 216. The police vehicle can send a signal on the public safety network with a message intended for the control center 100. The signal is received by the public safety radio 234a in the upgrade module. After the PHY 232a, MAC 230a and host interface hardware 220a process the signal, the signal passes to the host hardware controller 222. The host hardware controller examines the signal and determines that it is intended for the control center. The host hardware controller passes the signal to the host interface hardware 220b, MAC 230b, PHY 232b and backhaul radio 234b. The radio 234b broadcasts the signal containing the message to the backhaul 218 and the control center 100 receives the message. Conversely, the control center 100 can broadcast a message to the police vehicle 206. The control center broadcasts a signal containing the message to the backhaul 218 and the 5.8 GHz radio 234b receives the message. The PHY 232b, MAC 230b and host interface hardware 220b process the message and it is passed to the host hardware controller 222. The host hardware controller 222 examines the signal and determines that it is intended for police vehicle 206 and therefore must be transmitted on the public safety network 216. The signal is sent to host interface hardware 220a, MAC 230a, PHY 232a. The 4.9 GHz radio 234a then transmits the message to the public safety network 216 and it is received by police vehicle 206 (FIG. 6).

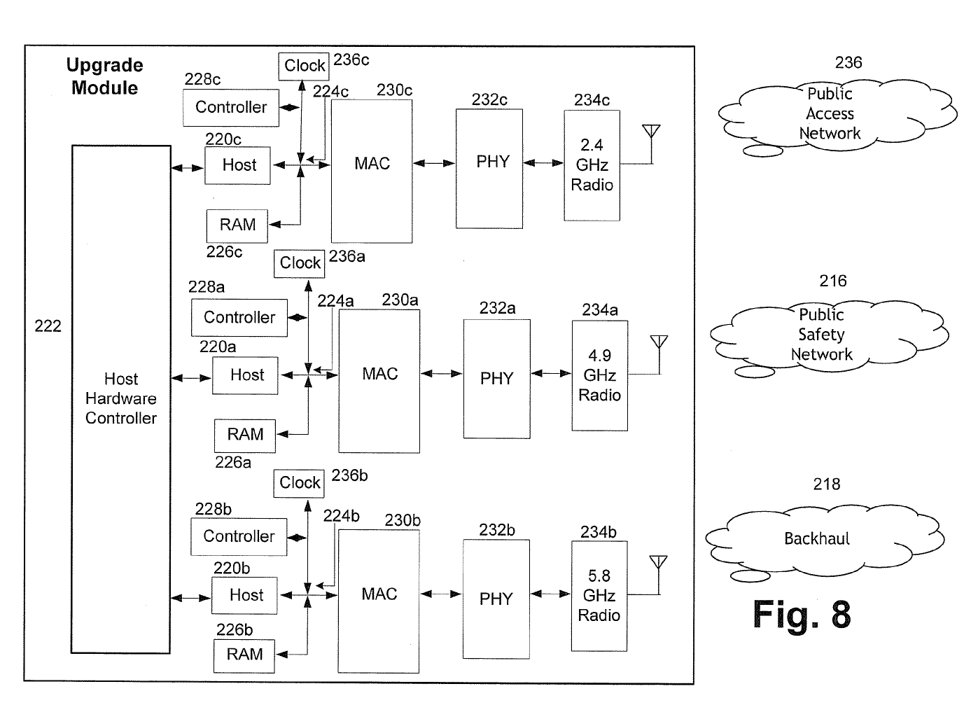

FIG. 8 illustrates another embodiment of a network upgrade module having a Wi-Fi transceiver, a public safety network transceiver and a back-haul transceiver for retroitting to an installed base of community assets such as the community warning system illustrated in FIG. 1. The transceivers and host hardware interface 222 in FIG. 8 operate similarly to the transceivers in FIG. 7. However, the module depicted in FIG. 8 also accepts public access network traffic. For example, a user can connect a laptop 212 (FIG. 6) to the public access network 236. The public access radio 234c in the upgrade module receives the signal. After the PHY 232c, MAC 230c and host interface hardware 220c process the signal, the signal passes to the host hardware controller 222. The host hardware controller examines the signal and determines that it is intended for the internet. The host hardware controller passes the signal to the host interface hardware 220b, MAC 230b, PHY 232b and backhaul radio 234b. The radio 234b broadcasts the signal containing the message to the backhaul 218 and the internet 174 (FIG. 6) receives the message.

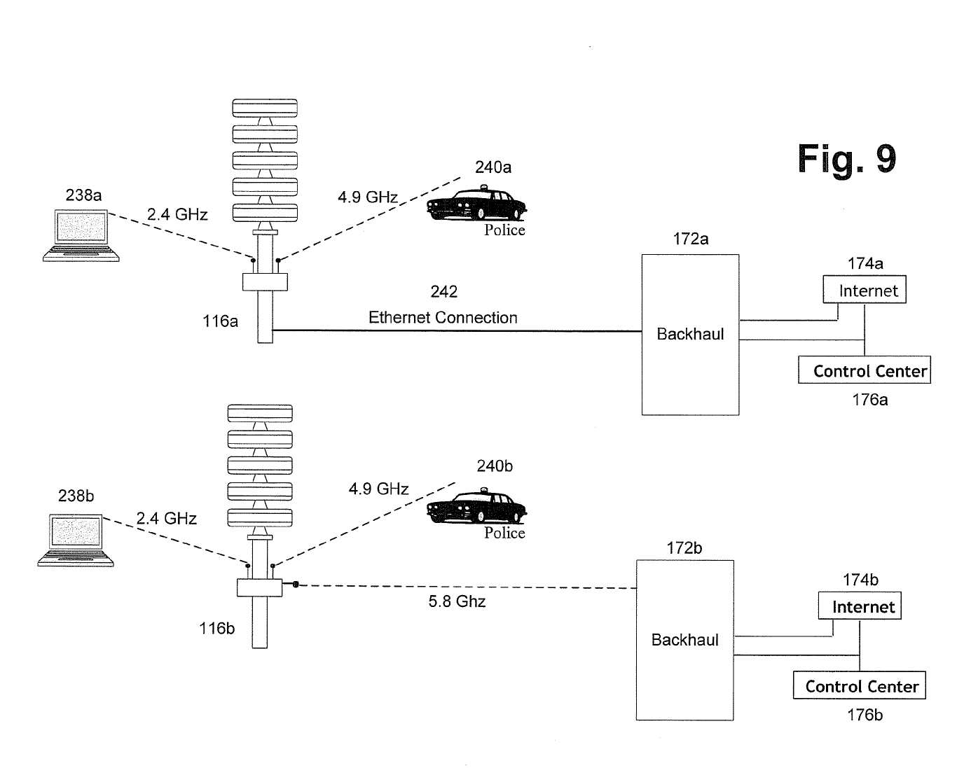

FIG. 9 illustrates various backhaul deployments in the community-wide, wireless network systems illustrated in FIGS. 4 and 5. The community warning system illustrated in FIG. 9 has been upgraded to support a public access network, a public safety network and a backhaul. Siren 116a connects to laptop 238a through a Wi-Fi public access network operating at 2.4 GHz. Siren 116a connects to police vehicle 240a using a public safety network operating at 4.9 GHz. A wired Ethernet connection 242 provides access to the backhaul 172a, internet 174a and control center 176a. Similarly, Siren 116b connects to laptop 238b through a Wi-Fi public access network operating at 2.4 GHz. Siren 116b connects to police vehicle 240b using a public safety network operating at 4.9 GHz. However, siren 116b connects to the backhaul 172b, internet 174b and control center 176b through a wireless network connection operating at 5.8 GHz.

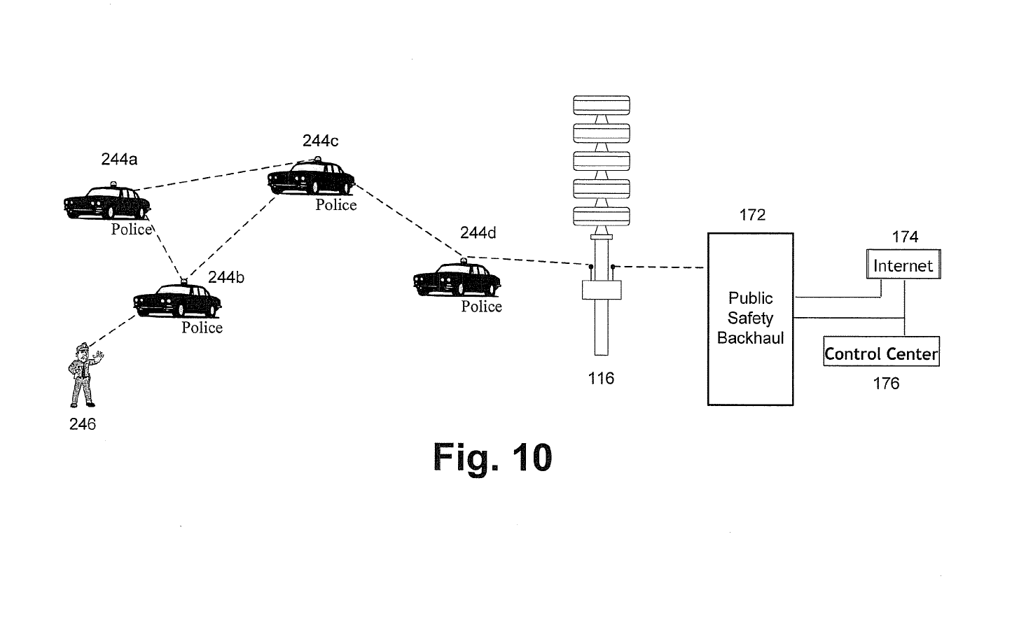

FIG. 10 illustrates a mobile ad hoc network normally supported by the community-wide, wireless network systems illustrated in FIGS. 4 and 5 that effectively patches holes in the network in the event that part of the infrastructure supporting the community-wide, wireless network is lost. If an event partially or completely destroys a community's network infrastructure, first responders and other trusted resources can continue to communicate with the control center and one another by forming an ad hoc network with at least one node also connecting to the community wide network or directly to the control center. Additionally, if an event occurs beyond the range of the community wide network, an ad hoc network can be established to extend the range of the community wide network so that the network reaches the emergency. In this example police cars 244a-d form an ad hoc network to patch a whole in the community wide network. The ad hoc network formed by police vehicles 244 allows other trusted resources to access the network. For example, police officer 246 uses a handheld device to connect to the community wide network through the ad hoc network established by police vehicles 244.

For example, police officer 248 uses a hand held device to send a message to the control center 176. The police officer 248 connects to police vehicle 244b using the public safety network. Police vehicle 244b transmits the message to police vehicle 244c, which transmits the message to police vehicle 244d. Police vehicle 244d uses the public safety network to transmit the message to siren 116. Siren 116 transmits the message to the backhaul 172. The control center 176 receives the message from the backhaul 172. In other embodiments of the invention, additional resources are used to form the ad hoc network and any trusted resource can connect to the public safety network through the ad hoc network. An ad hoc network can extend the range of public access networks in addition to public safety networks.

In alternative embodiments, the upgrade process starts by selecting a community-wide network. One example network suitable for upgrading is a Wi-Fi network. In an example implementation, the Wi-Fi network is a community-wide public access mesh network. At any node in the mesh network, public safety resources can be installed. For example, at one node in the network, a security monitoring camera can be installed. At another node in the network, an outdoor warning siren can be installed. Each of the public safety resources may communicate with a control center. In one embodiment, the resources use encrypted messages to communicate using the public access network. Thus, the public access network and the public safety network may operate at the same frequency and use the same network infrastructure, but the public safety network uses encrypted messages. In another embodiment, the public access network is used without encryption. In a preferred embodiment, additional transceivers are installed with the public safety resource to access a public safety network and/or a backhaul network to communicate with the control center.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of installing a community-wide emergency response network comprising:
upgrading an infrastructure supporting a public safety system comprising a plurality of sites distributed about the community to include one or more transceivers at each of the sites that cooperates with transceivers at other ones of the sites to provide the community-wide emergency response network; and
adding one or more network-enabled, trusted resources to the community-wide emergency response network such that each resource is enabled to communicate with another one of the resources or sites by way of the network.

2. The method of claim 1 further including extending the community-wide emergency response network by deploying at least one additional transceiver at a site outside of the public safety system that cooperates with at least one of the upgraded sites.

3. The method of claim 1 wherein the upgrading of the sites of the public safety system to provide the community-wide response network includes upgrading one or more of the sites to include transceivers supporting a public access network.

4. The method of claim 3 further including extending the public access network by deploying at least one additional transceiver at a site outside of the public safety system that cooperates with the transceivers supporting the public access network.

5. The method of claim 1 wherein the one or more network-enabled, trusted resources includes at least one of a (1) fire vehicle, (2) street sweeper, (3) sewage service vehicle, (4) police vehicle, (5) ambulance, (6) industrial facility, (7) parking gate, (8) fire station, (9) city garage, (10) smoke detector having network capabilities, (11) school house, (12) personal warning device, (13) highway message sign, 14) vehicle to vehicle warning, (15) Internet warning, (16) Intranet warning, (17) traffic light, (18) meteorological weather station, (19) walking path monitor, (20) automatic meter reading, (21) chemical, biological, radiological, nuclear, explosive sensors, (22) business alarm monitoring, (23) neighborhood watch video surveillance, (24) fire fighter monitoring, (25) policeman monitoring, (26) personal tracking devices and (27) license plate recognition systems (28) a train, and (29) a bus.

6. The method of claim 5 including providing a hard wired communications link between each of the network enabled, trusted resources and one of the transceivers supporting the community-wide emergency response network.

7. The method of claim 1 wherein the infrastructure is a system of dedicated radios.

8. The method of claim 1 wherein the public safety system is an outdoor emergency warning system.

9. The method of claim 1 wherein the community-wide emergency response network supports a IEEE 802.11 protocol.

10. The method of claim 1 wherein of the one or more transceivers at each of the upgraded sites includes a public access transceiver for supporting the public access network, a public safety transceiver for supporting the community-wide, emergency response network and a backhaul transceiver for supporting at least one of the public access and community-wide, emergency response network.

11. The method of claim 1 wherein at least one of the one or more network-enabled, trusted resources includes one of (1) fire vehicle, (2) street sweeper, (3) sewage service vehicle, (4) police vehicle, (5) ambulance, (6) industrial facility, (7) parking gate, (8) fire station, (9) city garage, (10) smoke detector having network capabilities, (11) school house, (12) personal warning device, (13) highway message sign, 14) vehicle to vehicle warning, (15) Internet warning, (16) Intranet warning, (17) traffic light, (18) meteorological weather station, (19) walking path monitor, (20) automatic meter reading, (21) chemical, biological, radiological, nuclear, explosive sensors, (22) business alarm monitoring, (23) neighborhood watch video surveillance, (24) fire fighter monitoring, (25) policeman monitoring, (26) personal tracking devices and (27) license plate recognition systems (28) a train, and (29) a bus.

12. The method of claim 11 including providing a wireless communications link between each of the network enabled, trusted resources and one of the transceivers supporting the community-wide emergency response network.

13. The method of claim 1 wherein one or more of the sites includes both local and external power supplies.

14. The method of claim 13 wherein the local power supply is one or more of (1) a battery, (2) a solar panel and (3) a fuel cell.

15. The method of claim 13 wherein a community power grid charges a local battery power supply.

16. The method of claim 1 wherein one or more of the sites includes a solar panel that charges a local battery power supply.

17. A method of deploying a community-wide public access network comprising:
upgrading an infrastructure supporting a public safety system comprising a plurality of sites distributed about the community to include at least one transceiver at each of the sites to provide the community-wide public access network; and
deploying at least one additional transceiver at a site outside of the sites comprising the public safety system for communicating with at least one of the plurality of sites upgraded to support the community-wide public access network.

18. The method of claim 17 further comprising utilizing encryption to implement a public safety network using the existing public access network.

19. The method of claim 17 further comprising extending the public safety system by adding a site to the plurality of sites comprising the public safety system that includes a transceiver for communicating with a network enabled public safety resource.

20. The method of claim 17 wherein each of the transceivers of the community-wide public access network includes one or more of (1) a Wi-Fi transceiver, (2) a Wi-Max transceiver, (3) a Hiperman transceiver, (4) a WiBro transceiver, (5) cellular telephony transceiver, and (6) a backhaul transceiver.

21. The method of claim 17 wherein the public safety system is an emergency warning system.

22. The method of claim 17 wherein the public safety system is a system of fire warning devices.

23. The method of claim 17 wherein each of the sites comprises a structure for supporting a warning siren at an elevation for broadcasting an audio warning signal to the community.

24. A method of deploying a public safety network comprising:
upgrading an infrastructure supporting a public safety system comprising a plurality of sites distributed about a community to include a transceiver at each of the sites that cooperates with transceivers at other ones of the sites to provide the public safety network; and
connecting one or more mobile, network-enabled, trusted resources to an upgraded one of the plurality of sites to enable each of the one or more connected resources to communicate with other resources in the public safety network.

25. The method of claim 24 further comprising extending at least one of the public safety network and the public access network by creating an ad hoc network comprising the one or more mobile network-enabled trusted resources.

26. The method of claim 25 wherein the mobile network enabled trusted resource is a vehicle equipped with a network enabled transceiver.

27. The method of claim 24 wherein the public safety system is an emergency warning system.

28. A method of deploying and communicating with a public safety resource in a community, the method comprising:
upgrading a node of a communications infrastructure supporting a community-wide network to include one or more dedicated public safety resources in communication with a public safety control center via the community-wide network; and
managing the one or more public safety resources by way of the communications between the control center and the one or more public safety resources.

29. The method of claim 28 wherein the community-wide network is one of a wireless public access network and a wireless public safety network.

30. The method of claim 29 wherein the upgrading of the node further includes installing at the node at least one of a transceiver for extending a wireless public safety network, a wireless public access network and a backhaul for a wireless network.

31. The method of claim 28 wherein the one or more dedicated public safety resources are hard wired to the node.

32. The method of claim 28 wherein the public safety resource includes at least one of a (1) surveillance camera, (2) an audio surveillance device, (3) a meteorological monitoring device and (4) a warning siren.
